(19) United States
(12) Patent Application Publication
(10) Pub. No.: US 2002/0141386 A1
(43) Pub. Date: Oct. 3, 2002

(54) System, apparatus and method for voice over internet protocol telephone calling using enhanced signaling packets and localized time slot interchanging

(76) Inventors: Brian D. Minert, Orem, UT (US); Gary D. Brown, Orem, UT (US)

Correspondence Address: TRASK BRITT, P.O. BOX 2550, SALT LAKE CITY, UT, 84110, US

(21) Appl. No.: 09/821,256

(22) Filed: Mar. 29, 2001

(51) Int. Cl. H04L 12/66

(52) U.S. Cl. 370/352; 370/401

(57) ABSTRACT

The present invention is a system, apparatus and method for voice over Internet protocol telephone (VoIP) calling using enhanced SS7 signaling packets and may include localized time slot interchanging. A system embodiment of the invention includes originating and terminating VoIP gateway switches in communication with the public switched telephone network (PSTN) and also in communication with an IP-based packet network, such as the Internet, for transmitting packets. The VoIP gateway switches are configured to exchange enhanced SS7 signaling packets over the IP-based packet network for setting up and tearing down VoIP telephone calls. A method of placing a VoIP telephone call in accordance with the present invention includes initiating a telephone call to a destination and connecting the telephone call to an originating VoIP gateway switch using enhanced SS7 signaling packets. The method also includes determining a preferred route from the originating VoIP gateway switch to the destination through an IP-based packet network and through a terminating VoIP gateway switch nearest said destination, and setting up two-way communication through the preferred route using the IP-based packet network using enhanced SS7 signaling packets.

### TECHNICAL FIELD

This invention relates generally to voice communications. More particularly, the invention relates to a system, apparatus and method for telephone communication over Internet Protocol (IP) based packet networks, such as the Internet, using enhanced SS7 signaling packets and localized time slot interchanging.

### BACKGROUND ART

The plain old telephone service (POTS) network, provides for the transmission and switching of 3 kHz analog voice telephone calls from a telephone or “handset” to a nearest central office (CO) of a local exchange carrier (LEC). A LEC is a telephone company which may have more than one CO or switching center. There are several types of LECs including (1), an incumbent local exchange carrier (ILEC), such as one of the old “Baby Bells”, e.g., Quest, PacBell, Bell South, etc., (2) newer telephone companies often referred to as a competitive local exchange carrier (CLEC), and (3) a “data only” LEC known as a data local exchange carrier (DLEC). The term “LEC” is used hereinafter to refer generally to all of these types of LEC, i.e., ILEC, CLEC and DLEC.

The POTS network is capable of providing realtime, low-latency, high reliability, and moderate fidelity voice telephony. However, it is not particularly well suited for other forms of communications, for example, wideband speech or audio, graphical image data, video, fax and other forms of data. Additionally, the POTS network is inherently designed for use with a “handset” or “telephone”. Other drawbacks associated with the POTS network include high access costs, and for international calls, settlement costs.

The public switched telephone network (PSTN) carries digital voice signals over wires and fiber optics in the United States and other countries for long distance telephone calls. The wires and fiber optics of the PSTN are owned by various long distance, carriers called IntereXchange Carriers (IXCs) (e.g., AT&T, Sprint, MCI, etc.) that charge whoever uses their wires and/or fiber optics by the minute. Generally, the PSTN is used to connect telephone calls and data transfers between LECs over the long distance wires and fiber optics and includes any intermediary switches. The PSTN, like the POTS network, suffers from high access costs.

All telecommunications systems having multiple switching offices require signaling between the offices. Telephone networks, such as the PSTN, require signaling between switching offices for transmitting routing and destination information, for transmitting alerting messages such as to indicate the arrival of an incoming call, and for transmitting supervisory information, e.g., relating to line status.

Signaling between offices can use “in-band” transport or “out-of-band” transport. In-band signaling utilizes the same channel that carries the communications between the parties. In a voice telephone system, for example, one of the common forms of in-band signaling between offices utilizes multi-frequency signaling over voice trunk circuits. The same voice trunk circuits also carry the actual voice traffic between switching offices. In-band signaling, however, tends to be relatively slow and ties up full voice channels during the signaling operations. In telephone call processing, a substantial percentage of all calls may go unanswered because the destination station is busy. For in-band signaling, the trunk circuit to the end office switching system serving the destination is setup and maintained for the duration of signaling until that office informs the originating office of the busy line condition. Thus, in-band signaling greatly increases congestion on the voice traffic channels. In-band signaling is also highly susceptible to fraud because hackers have developed devices to mimic in-band-signaling.

Out-of-band signaling evolved to mitigate the problems of in-band signaling. Out-of-band signaling utilizes separate channels, and in many cases, separate switching elements. Thus, out-of-band signaling reduces congestion on the payload carrying channels. Also, messages from the end users always utilize an In-band format and remain in-band, making difficult for hackers to simulate signaling messages which ride on an out-of-band channel or network. Out-of-band signaling utilizes its own signal formats and protocols and is not constrained by protocols and formats utilized for the actual payload communication. For this reason, out-of-band signaling typically is much faster than in-band signaling.

The PSTN includes a number of subnetworks. The two primary subnetworks are a circuit-switched voice subnetwork for carrying payload (in-band) and an out-of-band signaling subnetwork. Other PSTN subnetworks include packet subnetworks used for operations and network management functions. The PSTN circuit-switched voice subnetwork includes voice-grade circuits that can carry voice signals or data at multiples of a basic 64 kilobits/second rate. The terms “circuit-switched voice subnetwork” and “voice subnetwork” are used interchangeably herein. The voice subnetwork includes a plurality of Service Switching Points (SSPs) that are used to setup circuit-switched connections that carry voice traffic or data traffic, i.e., the “payload”, on the PSTN. Each SSP may be a switch used by a LEC, or a switch used by an IXC.

The PSTN signaling subnetwork is a packet-switched network, often referred to as the Common Channel Signaling (CCS) or sometimes as the Common Channel Interoffice Signaling (CCIS). Most such signaling communications for telephone networks utilize Signaling System 7 (SS7) protocol. The terms “SS7” and “SS7 protocol” are used interchangeably herein. SS7 is an international data network with signaling protocols that control the PSTN voice circuits and calls. SS7 has country-by-country variations. The International Telecommunications Union (ITU) SS7 is the base protocol upon which the national variants are based. The American National Standards Institute (ANSI) SS7 is the North American variant of SS7. The CCS carries packet-based digital information which assists in fast call setup and routing. The CCS also provides transaction capabilities using remote database interaction. The CCS includes a series of paired components connected to an SSP. Typically, each of the paired components for the CCS includes one or more Signal Transfer Points (STPs) and one or more Service Control Points (SCPs). Each STP and SCP provides a router and a database, respectively, used to implement call setup, call routing, call control and the logic (or programs) and related information functions used to provide advanced communications services over the PSTN. Details regarding the operation and functions of STPs and SCPs are well known to those of ordinary skill in the art, and thus, will not be further elaborated herein.

The SS7 protocol includes a series of subprotocols. Thus, for example, under the SS7 protocol, it is possible to automatically transfer information about the calling party to the called party, e.g., “Caller ID”. Additionally, CCS and SS7 interact with the voice subnetwork to enable a query from an SSP in the voice subnetwork to a SCP database in the CCS for determining how to route a call, such as a toll-free, or “800 number” call. Thus, for example, the SCP can return to the SSP a routing number corresponding to the dialed “800 number”. Other features or services of the voice and signaling subnetworks of the PSTN are well known to one of ordinary skill in the art, and thus, will not be further elaborated.

Packet-based networks are general-purpose data networks which are not tied to fixed-bandwidth circuits. Instead, they are designed to transmit bits, in the form of a packet of fixed or variable length, only when there are bits to transmit. In general, packet-based networks evolved independently of telephone networks for the purpose of moving non-realtime data among computers. Packet communications are routed by address information contained in the data stream itself. Packet-based networks are particularly well suited for sending stored data of various types, including messages, fax, speech, audio, video and still images, but are generally not well suited for sending realtime communication signals such as realtime speech, audio, and video signals.

There are a number of protocols for sending packets over a packet-based network. Internet protocol (IP) is the base protocol upon which the Internet packet-based network operates. The IP protocol, by itself, is not a “reliable” protocol, meaning it does not guarantee delivery and receipt of a packet. Various other protocols operate on top of the IP protocol. For example, transmission control protocol (TCP) operates on top of IP (sometimes referred to as TCP/IP) and is commonly used to guarantee delivery of a data packet from the sender to the receiver. TCP/IP is a “reliable” protocol that guarantees delivery and order of packets, but which has a lot of overhead associated with it and can take a long time guaranteeing packet transmission. TCP/IP is the protocol used on the public Internet with Web browser software. However, it is highly unsuitable for the transport of realtime data such as voice and video.

The user datagram protocol (UDP) is another IP-based protocol that delivers data in the same manner in which it was sent, e.g., if the sender transmits 20 bytes in a packet, they are delivered to the receiver as 20 bytes together. UDP is an “unreliable” protocol that does not guarantee delivery or order of packets, but which has little overhead. The realtime transport protocol (RTP) is a protocol that is used to transport realtime data, such as voice or video. RTP is an “unreliable” protocol built on top of the UDP protocol that does not guarantee delivery of packets, but which has little overhead. The realtime transport control protocol (RTCP) is used to report on the performance of a particular RTP transport session. RTCP delivers information such as the number of packets transmitted and received, the round-trip delay, jitter delay, etc. that are used to measure quality of service in an IP-based packet network.

Recently, the stream control transmission protocol (SCTP) was developed for transmitting SS7 messages over an IP-based packet network. Since an IP-based packet network typically does not guarantee delivery of messages through the network, nor provide for redundant physical paths through the network, the SCTP protocol performs these functions. Until SCTP was developed, it has been difficult if not impossible to transmit the kind of information that is contained in conventional SS7 protocol messages over an IP-based packet network. TCP, UDP, RTP and SCTP all operate on top of IP and use it as their transport protocol.

The Internet is the largest and probably the most well known of the existing packet-based networks. The Internet supports numerous applications such as electronic mail and the World Wide Web, which facilitates communications among persons around the world. Among the connections between computers typically found on the Internet are routers. Routers serve to send packets along to their destination by examining packet headers to determine the destination address. Routers often send packets to another router closer to the destination address.

Access to the Internet may be obtained through a point of presence (POP), typically through a server connected to one of the networks that make up the Internet. A large company or business may establish a POP as its own direct connection to the Internet. Individuals or small businesses typically obtain access to the Internet through an Internet service provider (ISP) which may provide a POP for many individuals and entities. Browsers for the World Wide Web provide a graphical user interface for users accessing the Internet. Internet users typically communicate over the Internet with a combination of hardware and software providing interconnectivity that is compatible with the Transmission Control Protocol/Internet Protocol (TCP/IP) standard. An IP-based packet network is a packet-based network that communicates using an IP-based protocol such as TCP/IP. The terms “World Wide Web” and “Web” are used interchangeably herein.

FIG. 1 illustrates a block diagram of an example of a conventional system 100 for voice over IP (VoIP) telephone calling from the Unites States to Europe. Conventional system 100 includes a telephone handset 202 located somewhere in the United States, where for example, a call is originated. Telephone handset 202 connects to a local exchange carrier (LEC) 204 through conventional analog telephone lines 206. LEC 204 switches the call through the PSTN (not shown) and connects to a VoIP gateway 108 through a plurality of T1 circuit-switched network trunk groups 110 (hereinafter “T1 lines 110”). FIG. 1 illustrates 4 T1 lines between LEC 204 and VoIP gateway 108. VoIP gateway 108 provides a bidirectional interface between T1 lines 110 on the PSTN and the Internet 216. Communication through the Internet 216 utilizes IP-based protocols, e.g., TCP/IP or derivatives thereof.

Another gateway 108 near the destination in Europe converts voice packets transmitted over the Internet 216 back to conventional voice signals that can communicate over the PSTN (or the European equivalent). In FIG. 1, VoIP gateway 108 in Europe receives voice packets from the Internet 216 and converts the voice packets to voice signals suitable for transmission over the E1 lines 114 (4 E1 lines shown, E1 being the European equivalent to T1 lines in the United States). While conventional VoIP telephone calling may include the use of a “signaling packet” for setting up a telephone call, the extent of the information included in such a conventional “signaling packet” is the destination number.

In Europe, telephone systems have been controlled in the past under various government agencies titled “Post, Telegraph and Telephone” (PTT). Today, most European telephone systems have been privatized and deregulated, and the term PTT is sometimes used to represent the system of telephone wires that now transport telephone calls for many telephone long distance carriers. PTT is still used as a local term in Europe to represent a telephone company (or LEC as in the United States) when referring to the telephone governing agency. The term “PTT” as referred to hereinafter, refers to the European equivalent of a LEC in the United States. Additionally, the term “C7” is used to refer to the European equivalent of the SS7 protocol in the United States.

Referring again to FIG. 1, PTT 224 switches the voice signals to the destination telephone handset 228 over conventional analog telephone lines 230. While the conventional VoIP system 100 can help reduce the cost of long distance telephone calls overseas, by taking advantage of low-cost transmission of data over the Internet, the performance of such a conventional VoIP system 100 is generally low because packet-based networks by themselves, are not designed for realtime (voice) data transmission. Additionally, a conventional VoIP gateway 108 will typically time slot interchange through the backplane (see additional discussion regarding time slot interchangers below) which reduces flexibility in selecting a preferred or least cost route for terminating a VoIP telephone call. A conventional terminating VoIP gateway 108 may also be limited by the number of circuit switch trunk lines they can connect to, further limiting flexibility in selecting a least cost route for completing a call.

Another approach to achieve VoIP is referred to as packet telephony. Packet telephony involves the use of a packet-based network, such as the Internet, for transmitting voice, audio, pictures, video and multimedia (e.g., audio and video) content. Rather than a pair of telephones connected by switched telephone lines, packet telephony typically involves the use of a “packet phone” or “Internet phone” at one or both ends of the telephony link, with the information transferred over a packet-based network using packet switching and packet routing techniques. The packet phone is typically a personal computer (PC) with a telephone and/or telephone line connected to the PC.

Conventional packet telephony is supposed to provide realtime speech communications over a packet-based network using the sound board of a multimedia PC to digitize speech into bits and use the processor of the PC to compress or encode the bitstream, packetize it, and send it to another multimedia PC over the packet-based network for decoding and realtime playback. However, in practice, packet telephony suffers from long transmission delays (e.g., due to packet size, packet buffering, packet overhead and routing delays), lost and delayed packets (e.g. due to network congestion), poor quality of the coded voice (e.g., due to the use of unsophisticated speech coders), difficulty of finding the IP address of the person at the destination and the need to call people who do not have access to the packet-based network. While several improvements have been suggested and made (e.g., reservation protocols, i.e., RSVP), packet telephony still leaves much to be desired.

A variation on packet telephony is known as a Hop-on Hop-off (HOHO) server. HOHO servers provide a mechanism for PC-initiated telephone calls on a packet-based network to connect with the PSTN and terminate at a customer's telephone handset or vice-versa. The HOHO server brings the packet-based network and PSTN together at a common gateway interface, which bidirectionally converts IP packets into voice and signaling information, such as the sequence of messages used to setup, bridge, and tear down telephone calls. Using HOHO servers, voice communication is established across the packet network and PSTN.

While HOHO servers and packet telephony provide limited usefulness for their specific applications, neither approach provides a comprehensive means for combining the call setup performance of the PSTN with SS7 and the low-cost data transmission associated with packet-based network (i.e., the Internet) in a way that takes full advantage of the signaling and realtime signal processing capabilities in the SS7 signaling protocol. For example, packet telephony systems do not take advantage of the SS7 signaling subnetwork and protocols to assist call setup and routing.

Another more recent approach to solving the above problems is disclosed in U.S. Pat. No. 6,134,235 to Goldman et al. The Goldman et al. patent discloses a system and method for bridging the POTS network and a packet-based network using a set of access objects that provide the interfacing and functionality for exchanging address and payload information with the packet-based network, and for exchanging payload information with the SS7. The Goldman et al. system includes a communications management object that coordinates the transfer of information between the PSTN and the packet-based network, a payload object that transfers payload information between the system and the payload subnetwork of the PSTN, a signaling object that transfers signaling information between the system and the SS7 in accordance with the SS7 protocol, and a packet object that transfers payload and address information between the system and a packet-based network. While the Goldman et al. system provides an interface between the PSTN and packet-based networks using the signaling capabilities of the SS7 over the PSTN, it does not appear to provide for end-to-end transmission of SS7 packets over a packet-based network. Rather, Goldman et al. appears to disclose the use of SS7 to facilitate VoIP call setup over the PSTN.

While various systems and methods for VoIP telephone calling have been proposed, none appear to disclose the use of a VoIP gateway switch capable of sending SS7 signaling packets over an IP-based packet network containing the kind of information that conventional SS7 protocol provides over the PSTN. Additionally, there does not appear to be any disclosure in the prior art of selecting a best route over an IP-based packet network for VoIP telephone calling using SS7 messaging over an IP-based packet network. Furthermore, it would be advantageous to perform VoIP telephone calling while avoiding the difficulties encountered with using conventional VoIP gateway protocols such as H.323, Media Gateway Control Protocol (MGCP) and Session Initiation Protocol (SIP), etc. to setup VoIP telephone calls.

### DISCLOSURE OF INVENTION

The present invention is a system, apparatus and method for performing voice over Internet protocol (VoIP) telephone calling using enhanced SS7 signaling packets and localized time slot interchanging.

A method for Voice over Internet Protocol (VoIP) telephone calling in accordance with the present invention includes initiating a telephone call to a destination associated with a destination telephone number and connecting the telephone call to an originating VoIP gateway switch. The method also includes determining a best route from the originating VoIP gateway switch to the destination through an IP-based packet network and through a terminating VoIP gateway switch nearest said destination using enhanced SS7 signaling packets, and setting up two-way communication through the best route using the IP-based packet network using enhanced SS7 signaling packets.

A VoIP gateway switch for switching VoIP telephone calls over a packet-based network in accordance with the present invention includes a backplane, wherein the backplane is pulse code modulated (PCM) and time division multiplexed (TDM) and a processor circuit board for controlling the VoIP gateway switch. VoIP gateway switch also includes at least one T1/E1 circuit board. The T1/E1 circuit board comprises T1/E1 connection circuitry for communicating with a T1/E1 line carrying a voice signals, a VoIP module in communication with the packet-based network, a local time slot interchanger (TSI) in communication with the T1/E1 connection circuitry and the VoIP module for coding and decoding voice signals and voice packets respectively. The T1/E1 circuit board further comprises a backplane TSI in communication with the local TSI and the PCM/TDM backplane.

A system embodiment of the present invention for placing VoIP telephone calls includes an originating telephone, a destination telephone and a local switch connected to the originating telephone through conventional analog or digital telephone lines for switching a telephone call originating between the originating telephone and a public switched telephone network (PSTN). The system also includes an originating VoIP gateway switch in communication with the PSTN and in communication with an IP-based packet network for transmitting packets. The packets may include enhanced SS7 signaling packets for setting up and tearing down VoIP telephone calls and voice packets for carrying voice data over the IP-based packet network. Both the enhanced SS7 signaling packets and the voice packets are transmitted over the IP-based packet network. The system may also include a terminating VoIP gateway switch in communication with the PSTN and in communication with the IP-based packet network and is configured for receiving and sending the packets over the IP-based packet network and transmitting conventional voice signals over said PSTN. The system may further include a remote switch for switching the voice signals between the terminating VoIP gateway switch and the destination telephone over the PSTN and conventional analog or digital telephone lines.

A method in accordance with the present invention for setting up Voice over Internet Protocol (VoIP) telephone calls using voice packets over an IP-based packet network or a public switched telephone network (PSTN) is also disclosed. The method includes providing an originating VoIP gateway switch configured to communicate over the IP-based packet network and the PSTN, providing a terminating VoIP gateway switch configured to communicate over the IP-based packet network and the PSTN. The method also includes initiating a VoIP telephone call through the originating VoIP gateway switch, sending an enhanced SS7 signaling packet from the originating VoIP gateway switch to the terminating VoIP gateway switch over the IP-based packet network and determining a best route for completing the VoIP telephone call. The method further includes setting up terminating VoIP settings based on the determined best route, sending an enhanced SS7 signaling reply packet back to the originating VoIP gateway switch including the terminating VoIP settings, receiving the enhanced SS7 signaling reply packet and finalizing the originating VoIP settings. The method may also include sending an enhanced SS7 signaling handshake packet and voice packets to start the VoIP telephone call, exchanging voice packets until a terminating event occurs and tearing down the VoIP telephone call by exchanging an SS7 signaling terminate packet. The SS7 signaling terminate packet may or may not be enhanced in accordance with the method of the invention.

These system and apparatus embodiments and methods of the present invention will be readily understood by reading the following detailed description in conjunction with the accompanying figures of the drawings.

### BRIEF DESCRIPTION OF DRAWINGS

In the drawings, which illustrate what is currently regarded as the best mode for carrying out the invention and in which like reference numerals refer to like parts in different views or embodiments:

FIG. 1 is a block diagram of a prior art system for conducting voice over Internet protocol (VoIP) telephone calls.

FIG. 2 is a block diagram of a system for conducting VoIP telephone calls in accordance with the present invention.

FIG. 3 is a detailed block diagram of a terminating VoIP gateway switch as illustrated in FIG. 2 and in accordance with the present invention.

FIG. 4 is a flow chart of a method for VoIP telephone calling in accordance with the present invention.

### DESCRIPTION OF THE INVENTION

Broadly speaking the invention is a system, apparatus and method for voice over Internet protocol (VoIP) telephone calling using enhanced SS7 signaling packets and localized time slot interchanging. The system, apparatus and method of the present invention addresses many of the problems associated with the prior art systems for VoIP telephone calling. VoIP telephone calling using the system, apparatus and method of the present invention are made more quickly than with conventional VoIP gateways using conventional VoIP gateway protocols such as H.323, Media Gateway Control Protocol (MGCP) and Session Initiation Protocol (SIP), etc. The system, apparatus and method of the present invention may provide for least cost routing look ahead and selection of available circuit switched telephone network trunk including onboard IP-based packet network switching resources. The system, apparatus and method of the present invention may also provide for increased telephone call capacity, reduced setup time, reduced cost, and avoidance of congested terminating VoIP gateway switches over conventional VoIP telephone calling systems and methods.

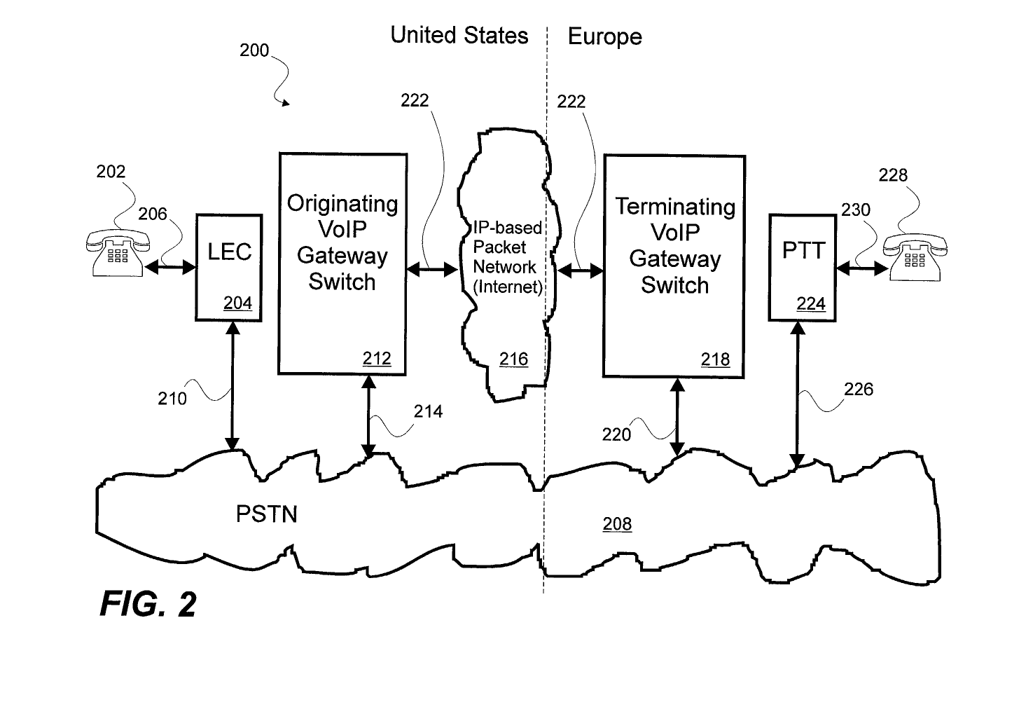

FIG. 2 is a block diagram of a system 200 for placing VoIP telephone calls in accordance with the present invention. System 200 includes an originating telephone 202 connected to a LEC 204 through conventional analog or digital telephone lines 206 or the POTS 206. LEC 204 is connected to the PSTN 208 via a plurality of T1 circuits 210. The terms “T1 circuits” and “T1 lines” are used interchangeably herein. System 200 also includes an originating VoIP gateway switch 212 which is connected to the PSTN 208 through a plurality of T1 circuit-switched network trunk groups 214. The originating VoIP gateway switch 212 is connected to an IP-based packet network 216 through an IP connection 222. System 200 also includes a terminating VoIP gateway switch 218 connected to the IP-based packet network 216 through an IP connection 222. As shown in FIG. 2, terminating VoIP gateway switch 218 may be located somewhere in Europe. Thus, terminating VoIP gateway switch 218 may be connected to the PSTN 208 through a plurality of E1 circuit-switched network trunk groups 220. System 200 further includes a PTT 224 connected to the PSTN 208 through E1 circuits 226 and also to a destination telephone 228 through conventional analog or digital phone lines 230.

IP-based packet network 216 may be the Internet. In a presently preferred embodiment, IP-based packet network 216 includes a private Internet with or without bandwidth on demand. In another presently preferred embodiment of the invention, both originating VoIP gateway switch 212 and terminating VoIP gateway switch 218 may comprise Specialty Telecommunications Exchange (STX™) switch or Integrated Protocols and Applications Xchange™ (IPAX™) gateway, Class 4, tandem switches, available from NACT Telecommunications, Inc., 191 West 5200 North, Provo, Utah, 84604, the assignee of the present invention. An STX™ or IPAX™ is presently configurable from 2 to 80 T1 spans or 2 to 64 E1 spans (48 to 1920 ports) in a single cabinet. Up to 4 STX™ or IPAX™ tandem switches may be connected together using a Master Control Unit (MCUTM) also available from NACT Telecommunications, Inc. The plurality of T1 circuit-switched network trunk groups 214 may include 120 T1 circuits capable of 2,880 simultaneous telephone calls or 120 E1 circuit-switched network trunk groups 214 capable of 3,600 simultaneous telephone calls. In another embodiment of the present invention, originating VoIP gateway switch 212 or terminating VoIP gateway switch 218 may include a single T1/E1 circuit card 302 with VoIP module 316 and a disk drive packaged in a small form factor rather than in a cabinet. IP connection 222 may support any IP-based protocol, e.g., user datagram protocol (UDP). In particular, IP connection 222 supports transmission of voice packets and enhanced SS7 signaling packets in accordance with the present invention.

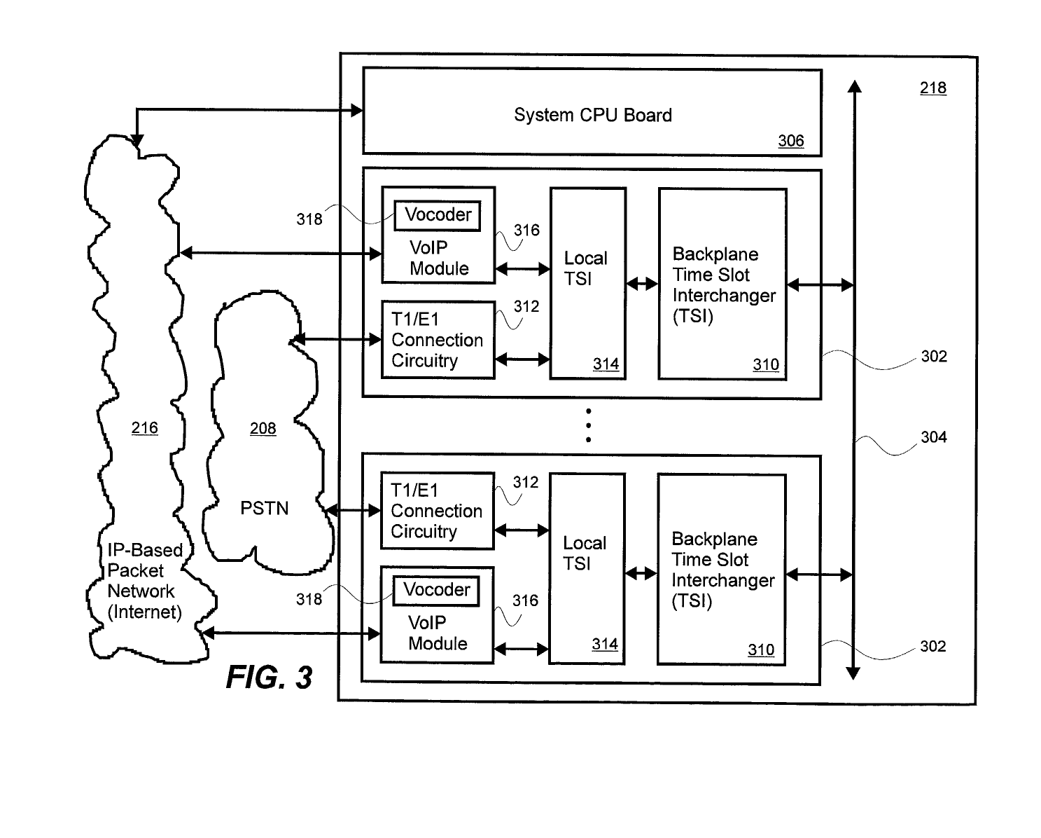

FIG. 3 is a detailed block diagram of a terminating VoIP gateway switch 218 as shown in FIG. 2 in accordance with the present invention. While a terminating VoIP gateway switch 218 is illustrated in FIG. 3, it should be noted that FIG. 3 may also be illustrative of an originating VoIP gateway switch 212 or a VoIP gateway switch with a single T1/E1 circuit card 302 as noted above. In a preferred embodiment, terminating VoIP gateway switch 218 is an STX™ or IPAX™, class 4, tandem switch. However, any VoIP gateway switch capable of performing the functions described herein may be used consistent with the present invention. The term “STX or IPAX compatible” gateway switch, as used herein refers to any VoIP gateway switch capable of performing the functions of a VoIP gateway switch as described herein including an STX™ or IPAX™, class 4, tandem switch. Additionally, a VoIP gateway switch (whether originating 212 or terminating 218 or any other embodiment) may also include input/output devices, e.g., a monitor, keyboard, mouse, etc., for use by an operator or technician. Furthermore, a VoIP gateway switch may also be configured for remote analysis, troubleshooting, and servicing, from any remote location over the PSTN 208 to which it is connected.

Terminating VoIP gateway switch 218 includes at least one T1/E1 circuit card 302 (two shown). Each T1/E1 circuit card 302 is connected to a pulse code modulated (PCM)/time division multiplexed (TDM) backplane 304. Terminating VoIP gateway switch 218 may also include a system central processing unit (CPU) board 306 in communication with each T1/E1 circuit card 302 through a system bus (not shown). The CPU board 306 does not communicate over the PCM/TDM backplane 304. System CPU board 306 is also configured for communicating with an IP-based packet network 216.

Each T1/E1 circuit card 302 may include T1/E1 connection circuitry 312 connected to the PSTN 208 and also connected to local, on-board, time slot interchanger (TSI) 314, hereinafter “local TSI 314”. Each local TSI 314 is connected to the PCM/TDM backplane 304. Each T1/E1 circuit card 302 may further include a VoIP module 316 containing vocoder software 318, hereinafter vocoder 318, connected to the local TSI 314 and also configured for connection to IP-based packet network 216. The term “vocoder”, as used herein, refers to features or procedures relating to voice signal compression and decompression for voice packet transmission and receiving, respectively. Additionally, a “vocoder”, as used herein, may be hardware-based, or a combination of software- and hardware-based. Each T1/E1 circuit card 302 may also include a backplane time slot interchanger (TSI) 310 in communication with the PCM/TDM backplane 304 for routing calls to other T1/E1 circuit cards 302. Alternatively, the backplane TSI may be a separate circuit card in communication with the each T1/E1 circuit card 302 over the PCM/TDM backplane 304.

Many telephone calls come into a T1 telephone switch and each telephone call has to be decoded to separate it from the other telephone calls (one of 24 channels from a single T1 line and a given switch may have numerous T1 lines). Each individual telephone call must be routed to the destination through some other channel usually on some other outbound T1 circuit. The outbound telephone call must be multiplexed into the other channels on the outbound T1 circuit.

A TSI, whether a local TSI 314 or backplane TSI 310, is an integral part of the TDM scheme of transporting multiple channels of voice data over a single set of wires. A TSI is used to decode and/or demultiplex an inbound channel (a single call) and multiplex and synchronize that decoded demultiplexed inbound channel to an outbound channel in a switch. In the context of a T1 line, there are up to 24 channels or telephone conversations on a single set of wires. Each channel on an inbound T1 circuit has a time slot that must be interchanged to an outbound channel time slot on another specific T1 circuit. The information carried on a T1 line is digitized and synchronized at 1.544 MHZ. The functions of a TDM telecommunications system and a TSI are within the knowledge of one of ordinary skill in the art, and thus, will not be further elaborated herein.

Referring to FIGS. 2 and 3, an example of how a VoIP telephone call may be routed through a terminating VoIP gateway switch 218 using a local TSI 314 follows. The originating telephone 202 initiates a VoIP telephone call through LEC 204 to the originating VoIP gateway switch 212 through the PSTN 208. The originating VoIP gateway switch exchanges enhanced SS7 signaling packets with the terminating VoIP gateway switch 218 to set up the VoIP telephone call. An enhanced SS7 signaling initiate packet is received by one of the plurality of T1/E1 circuit cards 302 in the terminating VoIP gateway switch 218. The method of analysis of the present invention is performed to determine the preferred route for completing the call. Assume that the preferred route may be completed through one of the trunk groups connected to a selected one of the plurality of T1/E1 circuit cards 302. The selected one of the plurality of T1/E1 circuit cards 302 may be different from the T1/E1 circuit card 302 that first received the enhanced SS7 signaling initiate packet. Call settings are finalized by exchanging enhanced SS7 reply and handshake packets. Then voice packets may be received by the VoIP module 316 in the terminating VoIP gateway switch 218, decoded into a voice signal by vocoder 318, routed through local TSI 314 to the T1/E1 connection circuitry 312 on the same T1/E1 circuit card 302 and back out to the PSTN 208. From the PSTN 208, the voice signals will be switched through the PTT 224 to the destination telephone 228. Voice signals from the destination telephone 228 make the reverse journey back to the originating telephone 202 in accordance with the present invention.

Referring again to FIGS. 2 and 3, an example of how a VoIP telephone call may be routed through a terminating VoIP gateway switch 218 using a backplane TSI 310 follows. The originating telephone 202 initiates a VoIP telephone call through LEC 204 to the originating VoIP gateway switch 212 through the PSTN 208. The originating VoIP gateway switch exchanges enhanced SS7 signaling packets with the terminating VoIP gateway switch 218 to set up the VoIP telephone call. The enhanced SS7 signaling packets are received by one of the T1/E1 circuit cards 302. Assume further that the preferred route may be completed through one of the trunk groups connected to a second T1/E1 circuit card 302 housed in the terminating VoIP gateway switch 218. Then voice packets may be received by a VoIP module 316 from the originating VoIP gateway switch 212, decoded into a voice signal by vocoder 318, routed through a first local TSI 314 to a first backplane TSI 310 and out onto the PCM/TDM backplane 302, off of the PCM/TDM backplane 302 and into a second backplane TSI 310 on the second T1/E1 circuit card 302, through a second local TSI 314 and then through T1/E1 connection circuitry 312 on the second T1/E1 circuit card 302 and back out to the PSTN 208. From the PSTN 208, the voice signals will be switched through the PTT 224 to the destination telephone 228. Voice signals from the destination telephone 228 make the reverse journey back to the originating telephone 202 in accordance with the present invention.

Referring again to FIGS. 2 and 3, a method of a VoIP telephone calling in accordance with the present invention is described. A telephone call is placed from any telephone 202 connected through a LEC 204 to the PSTN 208. For simplicity, the term PSTN 208 is used in this discussion to refer not only to the public switched telephone network in the United States and its associated LEC and SS7 protocol, but also to the PTT and C7 equivalents over in Europe, for example. The call is switched through the PSTN 208 to an originating VoIP gateway switch 212. The originating VoIP gateway switch 212 determines the telephone number of the calling party, the destination telephone number requested and additional internal identification information about the calling party including billing or prepaid privileges. Determining the telephone number of the calling party, may be accomplished, for example and not by way of limitation, by automatic number identification (ANI) or by calling line identification (CLI), as known to one of ordinary skill in the art. The originating VoIP gateway switch 212 is configured to connect to a plurality of T1 lines. A particular embodiment of an originating VoIP gateway switch 212 may be configured to connect to 120 T1 lines.

The terminating VoIP gateway switch 218 is connected to more than one PSTN trunk group 220, i.e., a multiplicity of PSTN trunks in the terminating VoIP gateway switch 218 are connected to a plurality of circuit-switched switches. The terminating VoIP gateway switch 218 is configured to determine a preferred route for a telephone call to the destination telephone number at telephone 228. While a single PTT 224 is shown, the terminating VoIP gateway switch 218 of the present invention is configured to connect directly to a multiplicity of LECs or PTTs, thus, allowing for selection of lowest cost service providers each providing different quality, grade or cost of services.

The originating VoIP gateway switch 212 determines a VoIP address for a terminating VoIP gateway switch 218 that can terminate the call to, or near, the destination telephone number at telephone 228, using any one routing criteria or any combination of routing criteria. Such routing criteria may include least-cost, quality-of-service, grade-of-service and preferred carrier. The routing criteria selected for a particular call is referred to herein as the selected routing criteria.

The originating VoIP gateway switch 212 is configured to send two kinds of packets over the IP-based packet network 216 using IP connections 222 to the terminating VoIP gateway switch 218 near the destination telephone 228. The first kind of packet sent and received by the originating VoIP gateway switch 212 is an enhanced SS7 signaling packet, which carries the conventional SS7 telephony information (e.g., destination telephone number) and additional (or enhanced) signaling information needed for interaction over the IP-based packet network 216 between the originating VoIP gateway switch 212 and the terminating VoIP gateway switch 218. Such additional or enhanced signaling information may be included in the Access Transport Field as defined in the SS7 protocol. The term “enhanced SS7 signaling packet”, as used herein, is inclusive of “enhanced SS7 signaling initiate packet”, “enhanced SS7 signaling reply packet”, “enhanced SS7 signaling handshake packet”, “SS7 signaling terminate packet” and “enhanced SS7 signaling terminate packet” as further defined herein. The second kind of packet sent and received by the originating VoIP gateway switch 212 is a voice packet, a plurality of which are used to carry the telephone call conversation.

The terminating VoIP gateway switch 218 is also configured to transmit and receive the same two kinds of packets over the IP-based packet network 216. It will be recognized by one of ordinary skill in the art that an enhanced SS7 signaling packet may be broken up into a plurality of enhanced SS7 signaling packets without departing from the scope of the invention. For simplicity of discussion, a single enhanced SS7 signaling packet containing all of the necessary information for a particular signaling task is assumed in this discussion.

When initiating a call, the originating VoIP gateway switch 212 is configured to send an enhanced SS7 signaling initiate packet to the terminating VoIP gateway switch 218. The enhanced SS7 signaling initiate packet may include such additional signaling information as one or more RTP, RTCP and T.38 fax port addresses in an originating VoIP gateway switch 212 that may be used for receiving voice packets sent from the terminating VoIP gateway switch 218. The additional signaling information may also include a list of available vocoders in the originating VoIP gateway switch 212 that may be used for voice compression. As of this writing, there are up to twenty seven vocoder choices that can be made. Selection from the list of available vocoders is performed at the terminating VoIP gateway switch 218.

The terminating VoIP gateway switch 218 receives the enhanced SS7 signaling initiate packet from the originating VoIP gateway switch 212 and analyzes how to best complete the call at the terminating VoIP gateway switch 218, i.e., determining “terminating VoIP settings”. The analysis includes identifying an available trunk group 220 from a plurality of candidate trunk groups, selecting a switching circuit (or T1/E1 connection circuitry 312, see FIG. 3) associated with the identified available trunk group having a VoIP module with available VoIP capacity and selecting specific terminating RTP, RTCP and T.38 fax port addresses in the VoIP module associated with the selected switching circuit to complete the call to the destination number. The terms “switching circuit” and “T1/E1 connection circuitry” are used interchangeably herein.

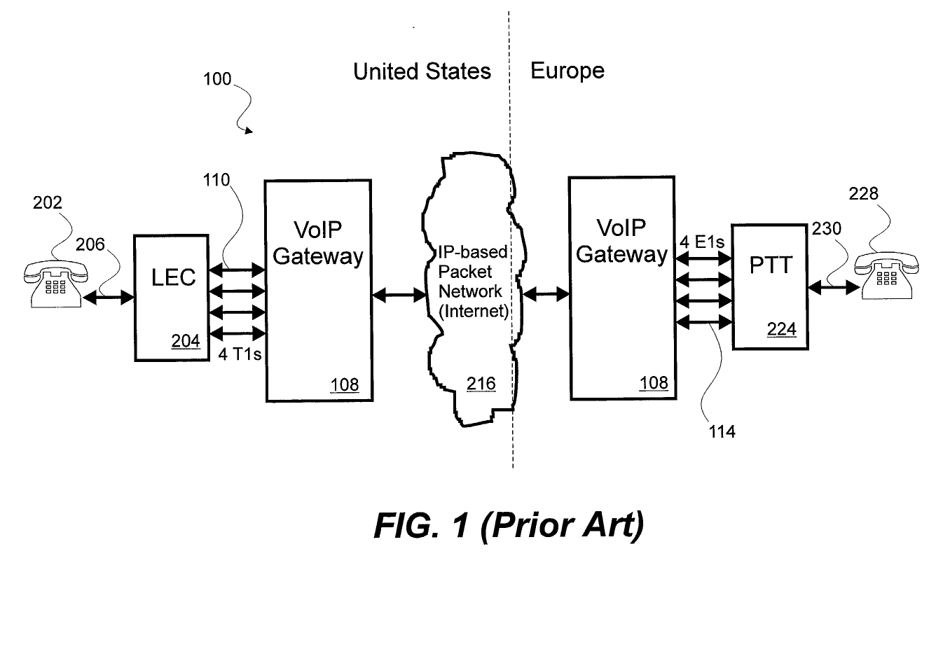

Selecting an available trunk group from a plurality of candidate trunk groups includes identifying one of a plurality of circuit-switched network trunk groups that has circuits available for terminating the call through the PSTN 208 to the destination telephone number through the PTT 224 based on one of a plurality of routing criteria or any combination thereof (i.e., “selected routing criteria”). Routing criteria may include, for example and not by way of limitation, least-cost, quality-of-service, grade-of-service and preferred carrier. If there are no candidate trunk groups 220 having circuits available for terminating the call through the PSTN 208, then the terminating VoIP gateway switch 218 sends an SS7 signaling terminate packet back to the originating VoIP gateway switch 212 indicating no remote circuit available. The originating VoIP gateway switch 212 can then select another route, including another VoIP gateway switch. Selecting an available trunk group 220 may include the terminating VoIP gateway switch 218 checking each candidate trunk group 220 in turn for the first trunk group that meets the selected routing criteria. The first trunk group that meets the selected routing criteria is selected as the “available trunk group”. Note that with conventional VoIP systems, there are typically not enough PSTN switching circuits to allow simultaneous connections to various circuit switched carriers (e.g., LEC, PTT, etc., see FIG. 1). Therefore, the choice of trunk group based upon the inventive analysis and routing criteria, such as least cost routing, may be difficult to perform, or has not been performed in the past, with conventional VoIP systems and methods.

Once an available trunk group has been selected, the terminating VoIP gateway switch 218 selects a switching circuit configured for connection to the available trunk group with available VoIP capacity. Selecting a switching circuit with available VoIP capacity includes searching from among a plurality of switching circuits within the terminating VoIP gateway switch 218 that may be connected to the available trunk group for an available switching circuit with available VoIP capacity. An available switching circuit is a switching circuit that is not currently switching voice signals. Available VoIP capacity refers to VoIP circuitry (and/or software or firmware) for converting voice signals to voice packets and vice versa that is not currently performing that function on a given VoIP module 316.

Once a switching circuit with available VoIP capacity has been selected, the terminating VoIP gateway switch 218 identifies terminating RTP, RTCP and T.38 fax port addresses in the VoIP module associated with the selected switching circuit which the call can be terminated. Additionally, a vocoder is selected from the list of available vocoders previously sent by the originating VoIP gateway switch 212. The terminating RTP, RTCP and T.38 fax port addresses and the selected vocoder may be referred to as “terminating VoIP settings”.

Once the terminating VoIP settings are determined, the terminating VoIP gateway switch 218 prepares and sends an enhanced SS7 signaling reply packet back to the originating VoIP gateway switch 212. The enhanced SS7 signaling reply packet includes the terminating RTP, RTCP and T.38 fax port addresses in the terminating VoIP gateway switch 218 for receiving voice packets sent from the originating VoIP gateway switch 212. The enhanced SS7 signaling reply packet also contains the selected vocoder 318 that will be used for voice signal compression and packet coding and packet decoding and voice signal decompression by both the originating VoIP gateway switch 212 and the terminating VoIP gateway switch 218.

Once the enhanced SS7 signaling reply packet has been sent, or concurrently with sending the reply packet to the originating VoIP gateway switch 212, the terminating VoIP gateway switch 218 sets up the terminating VoIP settings so that it may send and receive voice packets to and from the originating VoIP gateway switch 212 upon receipt of an enhanced SS7 signaling handshaking packet from the originating VoIP gateway switch 212.

The originating VoIP gateway switch 212 receives the enhanced SS7 signaling reply packet and finalizes the originating VoIP settings so that it can send packets to, and receive packets from, the terminating VoIP gateway switch 218. Originating VoIP gateway switch 212 also activates delivery of voice packets to the RTP, RTCP and T.38 fax port addresses of the terminating VoIP gateway switch 218 identified in the enhanced SS7 signaling reply packet. Additionally, originating VoIP gateway switch 212 sends an enhanced SS7 signaling handshake packet back to the terminating VoIP gateway switch 218 to confirm the VoIP call is set up and activated.

The terminating VoIP gateway switch 218 receives the enhanced SS7 signaling handshake packet from the originating VoIP gateway switch 212 and activates the terminating VoIP settings to transmit voice packets to, and receive voice packets from, the originating VoIP gateway switch 212. Voice packets are then transmitted in both directions through the IP-based packet network 216 to execute the VoIP telephone call. The VoIP telephone call is terminated when the caller, or the called party hangs up, disconnects, or terminates the call, or either of the VoIP gateway switches forces a call termination for any reason. Upon such a terminating event, an SS7 signaling terminate packet is exchanged between the VoIP gateway switch that sensed the terminating event to the other VoIP gateway switch and the call is torn down, i.e., the originating VoIP settings and terminating VoIP settings are released. The SS7 signaling terminate packet may or may not be enhanced SS7 in accordance with the present invention. That is to say that the SS7 signaling terminate packet may be a conventional SS7 packet for terminating a call, but it is still transmitted over the IP-based packet network which has not been performed or disclosed by conventional VoIP systems and methods.

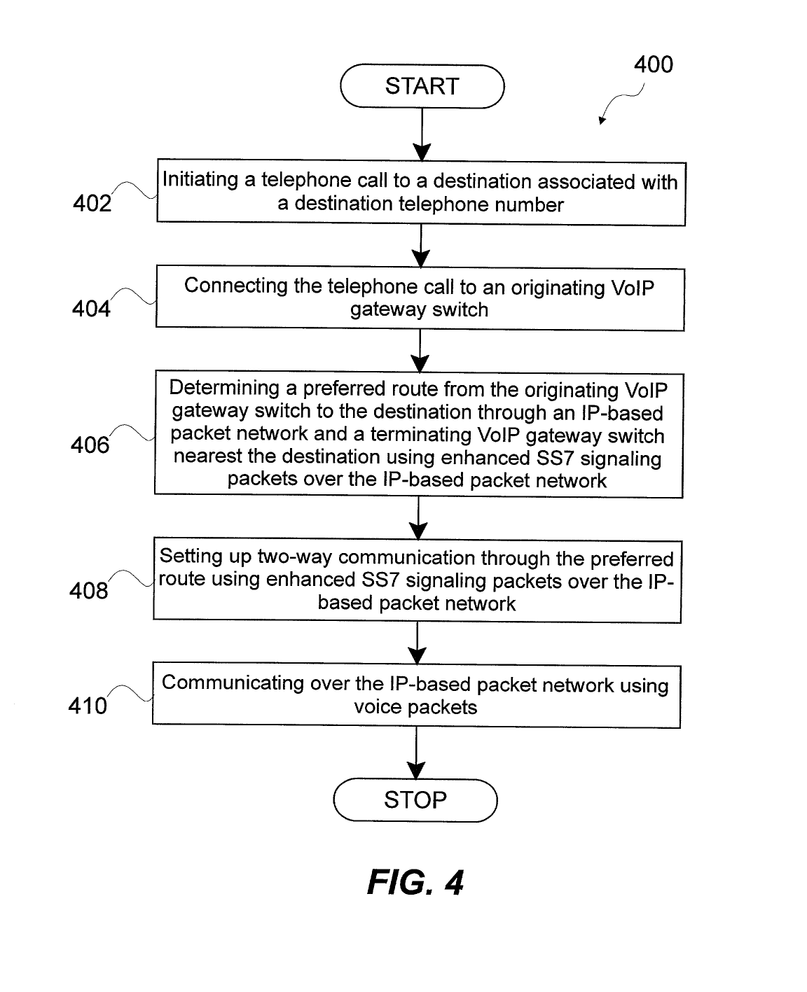

FIG. 4 is a flow chart of a method 400 for VoIP telephone calling in accordance with the present invention. Method 400 may include initiating 402 a telephone call to a destination associated with a destination telephone number, connecting 404 the telephone call to an originating VoIP gateway switch. Method 400 may further include determining 406 a preferred route from the originating VoIP gateway switch 212 to the destination through an IP-based packet network and a terminating VoIP gateway switch 218 nearest the destination using enhanced SS7 signaling packets over the IP-based packet network. Determining 406 a preferred route may be performed in accordance with the above description for FIGS. 2 and 3. Method 400 may further include setting up 408 two-way communication through the preferred route using the IP-based packet network using enhanced SS7 signaling packets over the IP-based packet network. Setting up 408 two-way communication through the preferred route may be performed in accordance with the above description for FIGS. 2 and 3. Method 400 may further include communicating 410 over the IP-based packet network using voice packets. Method 400 may also include tearing down the VoIP telephone call in response to a terminating event.

Although this invention has been described with reference to particular embodiments, the invention is not limited to these described embodiments. Rather, it should be understood that the embodiments described herein are merely exemplary and that a person skilled in the art may make many variations and modifications without departing from the spirit and scope of the invention. All such variations and modifications are intended to be included within the scope of the invention as defined in the appended claims.

What is claimed is:

1. A method for Voice over Internet Protocol (VoIP) telephone calling over an IP-based packet network comprising:
initiating a telephone call to a destination associated with a destination telephone number;
connecting said telephone call to an originating VoIP gateway switch over a public switched telephone network (PSTN);
determining a preferred route from said originating VoIP gateway switch to said destination through said IP-based packet network and through a terminating VoIP gateway switch nearest said destination using enhanced SS7 signaling packets; and
setting up two-way communication through said preferred route using enhanced SS7 signaling packets over said IP-based packet network.

2. The method of claim 1, wherein connecting said telephone call to an originating VoIP gateway switch comprises:
switching said telephone call through a local switch to said PSTN; and
switching said telephone call from said PSTN to said originating VoIP gateway switch.

3. The method of claim 2, wherein said local switch comprises a central office (CO).

4. The method of claim 2, wherein said local switch is selected from the group consisting of a Local Exchange Carrier (LEC), an Incumbent Local Exchange Carrier (ILEC), a Competitive Local Exchange Carrier (CLEC), a Data Local Exchange Carrier (DLEC), a Post, Telegraph and Telephone (PTT), an IntereXchange Carrier (IXC) and an Internet Service Provider (ISP).

5. The method of claim 1, wherein said determining a preferred route comprises:
determining a telephone number associated with a calling party, said destination telephone number and any internal identification information about said calling party; and
determining switching parameters for said terminating VoIP gateway switch based on selected routing criteria.

6. The method of claim 5, wherein said determining said telephone number associated with said calling party comprises automatic number identification.

7. The method of claim 5, wherein said determining said telephone number associated with said calling party comprises calling line identification.

8. The method of claim 5, wherein said selected routing criteria comprises least-cost routing.

9. The method of claim 5, wherein said selected routing criteria comprises quality of service.

10. The method of claim 5, wherein said selected routing criteria comprises grade of service.

11. The method of claim 5, wherein said selected routing criteria comprises preferred carrier.

12. The method of claim 1, wherein said setting up two-way communication comprises:
sending an enhanced SS7 signaling initiation packet comprising:
a destination telephone number;
an originating port address of a VoIP module in said originating VoIP gateway switch for receiving voice packets from said terminating VoIP gateway switch; and
a list of available vocoders for voice compression and decompression;
selecting a terminating port address of a VoIP module in said terminating VoIP gateway switch for receiving voice packets from said originating VoIP gateway switch;
selecting a vocoder from said originating vocoder list for voice compression and decompression to be used at said originating and said terminating VoIP gateway switches; and
returning an enhanced SS7 signaling reply packet comprising:
said terminating port addresses; and
said selected vocoder.

13. The method of claim 12, wherein said selecting a terminating port address further comprises:
identifying available circuit-switched network trunk groups connected to said terminating VoIP gateway switch having switching circuits available for terminating said telephone call to said destination through said PSTN in accordance with selected routing criteria;
selecting a switching circuit configured for connection to one of said identified available circuit-switched network trunk groups; and
identifying said terminating port address of a VoIP module associated with said selected switching circuit in said terminating VoIP gateway switch having available VoIP capacity.

14. The method of claim 12, wherein said selected routing criteria comprises any combination of least-cost routing, quality of service, grade of service and preferred carrier.

15. The method of claim 1, wherein said originating VoIP gateway switch and said terminating VoIP gateway switch each comprise an STX or IPAX compatible gateway switch.

16. The method of claim 15, wherein said STX or IPAX compatible gateway switch comprises a plurality of T1/E1 circuit boards.

17. The method of claim 16, wherein each of said T1/E1 circuit boards comprises:
T1/E1 connection circuitry configured for switching conventional voice signals to and from said PSTN;
a local time slot interchanger (TSI) connected to said T1/E1 connection circuitry;
a backplane TSI in communication with said local TSI and a pulse code modulated (PCM)/time division multiplexed (TDM) backplane for interfacing with other of said T1/E1 circuit boards also connected to said PCM/TDM backplane in said STX or IPAX compatible gateway switch; and
a VoIP module connected to said local TSI and configured for sending and receiving packets through said IP-based packet network.

18. The method of claim 17, wherein said VoIP module further includes a vocoder for compressing and encoding voice signals and for decompressing and decoding voice packets.

19. The method of claim 1, further comprising:
communicating voice signals over said IP-based packet network; and
tearing down said telephone call after a calling party or a called party hangs up, disconnects, or terminates said telephone call, or either VoIP gateway switch forces a disconnect or termination of said telephone call for any reason.

20. A Voice over Internet Protocol (VoIP) gateway switch for switching VoIP telephone calls over an IP-based packet network comprising:
a pulse code modulated (PCM) and time division multiplexed (TDM) backplane;
a system central processor unit (CPU) board configured to communicate with said IP-based packet network and for controlling said VoIP gateway switch;
a plurality of T1/E1 circuit boards, each in communication with said system CPU board, each of said plurality of T1/E1 circuit boards comprising:
T1/E1 connection circuitry configured for switching conventional voice signals over a public switched telephone network (PSTN);
a local time slot interchanger (TSI) connected to said T1/E1 connection circuitry;
a backplane TSI in communication with said local TSI and said PCM/TDM backplane for routing voice signals to and from another of said plurality of T1/E1 circuit boards connected to said PCM/TDM backplane in said gateway switch; and
a VoIP module connected to said local TSI and configured for sending and receiving packets through said IP-based packet network.

21. A Voice over Internet Protocol (VoIP) gateway switch for switching VoIP telephone calls over an IP-based packet network comprising:
a pulse code modulated (PCM) and time division multiplexed (TDM) backplane;
a system central processor unit (CPU) board configured to communicate with said IP-based packet network and for controlling said VoIP gateway switch;
a plurality of T1/E1 circuit boards, each in communication with said system CPU board, each of said plurality of T1/E1 circuit boards comprising:
T1/E1 connection circuitry configured for switching conventional voice signals over a public switched telephone network (PSTN); and
a VoIP module configured for sending and receiving packets through said IP-based packet network; and
a local time slot interchanger (TSI) connected to said T1/E1 connection circuitry and said VoIP module for routing calls between said PSTN and said IP-based packet network; and
a backplane TSI in communication with said PCM/TDM backplane for routing voice signals between two of said plurality of T1/E1 circuit boards.

22. A system for placing Voice over Internet Protocol (VoIP) telephone calls comprising:
an originating telephone;
a destination telephone;
a local switch connected to said originating telephone through conventional analog or digital telephone lines for switching a telephone call originating between said originating telephone and a public switched telephone network (PSTN);
an originating VoIP gateway switch in communication with said PSTN and in communication with an IP-based packet network for transmitting packets, said packets comprising:
enhanced SS7 signaling packets for setting up and tearing down said VoIP telephone calls; and
voice packets for carrying voice data over said IP-based packet network;
a terminating VoIP gateway switch in communication with said PSTN and in communication with said IP-based packet network and configured for receiving and sending said packets over said IP-based packet network and transmitting voice signals over said PSTN; and
a remote switch for switching said voice signals between said terminating VoIP gateway switch and said destination telephone over said PSTN and conventional analog or digital telephone lines.

23. The system of claim 22, wherein said IP-based packet network comprises an Internet.

24. The system of claim 23, wherein said Internet comprises a private Internet including bandwidth on demand.

25. A method for setting up Voice over Internet Protocol (VoIP) telephone calls using voice packets over an IP-based packet network or a public switched telephone network (PSTN) comprising:
providing an originating VoIP gateway switch configured to communicate over said IP-based packet network and said PSTN;
providing a terminating VoIP gateway switch configured to communicate over said IP-based packet network and said PSTN;
initiating a VoIP telephone call through said originating VoIP gateway switch;
sending an enhanced SS7 signaling initiate packet from said originating VoIP gateway switch to said terminating VoIP gateway switch over said IP-based packet network;
determining a preferred route for completing said VoIP telephone call;
setting up terminating VoIP settings based on said determined preferred route;
sending an enhanced SS7 signaling reply packet back to said originating VoIP gateway switch including said terminating VoIP settings;
receiving said enhanced SS7 signaling reply packet and finalizing said originating VoIP settings;
sending an enhanced SS7 signaling handshake packet and voice packets to start said VoIP telephone call;
exchanging said voice packets until a terminating event occurs; and
tearing down said VoIP telephone call by exchanging an optionally enhanced SS7 signaling terminate packet.

26. The method of claim 25, wherein said enhanced SS7 signaling initiate packet comprises:
destination telephone number;
a port address in said originating VoIP gateway switch for receiving said voice packets from said terminating VoIP gateway switch; and
a vocoder list in said originating VoIP gateway switch for compressing and decompressing voice signals sent and received, respectively, by said originating VoIP gateway switch over said IP-based packet network.

27. The method of claim 26, wherein said enhanced SS7 signaling reply packet comprises:
a terminating port address in said terminating VoIP gateway switch for receiving said voice packets from said originating VoIP gateway switch; and
a vocoder selected from said vocoder list in said terminating VoIP gateway switch for compressing and decompressing voice signals sent and received, respectively, by said terminating VoIP gateway switch over said IP-based packet network.

28. A circuit card for switching voice signals from a public switched telephone network to an IP-based packet network comprising:
T1/E1 connection circuitry configured for switching conventional voice signals to and from said PSTN;
a local time slot interchanger (TSI) connected to said T1/E1 connection circuitry;
a backplane TSI in communication with said local TSI and a pulse code modulated (PCM)/time division multiplexed (TDM) backplane for interfacing with other of said T1/E1 circuit boards also connected to said PCM/TDM backplane in said STX or IPAX compatible gateway switch; and
a VoIP module connected to said local TSI and configured for sending and receiving packets through said IP-based packet network.

29. The circuit card of claim 28, wherein said VoIP module further comprises a vocoder configured for compressing voice signals and generating voice packets and receiving voice packets and decompressing voice packets to generate voice signals.

30. The circuit card of claim 29, wherein said vocoder further comprises a plurality of selectable voice coding and decoding features to be selected by a terminating VoIP gateway switch on a per call basis.

31. A method for providing voice over Internet protocol (VoIP) telephone calls over an IP-based packet network comprising:
determining a least cost routing for a destination telephone number;
selecting an available circuit switched telephone network trunk having available IP-based packet network switching resources; and
selecting a VoIP module at a terminating gateway based on said least cost routing and available IP-based packet network switching resources.

32. The method of claim 31, further comprising exchanging enhanced SS7 signaling packets over said IP-based packet network.

33. A method for increasing the capacity of a voice over Internet protocol (VoIP) gateway switch comprising providing a localized time slot interchanger (TSI) on a T1/E1 circuit card including VoIP module for communication over an IP-based packet network for on-board routing of a call between said IP-based packet network and a public switched telephone network (PSTN).

34. A method for reducing call setup time between an originating voice over Internet protocol (VoIP) gateway switch and a terminating VoIP gateway switch comprising exchanging enhanced SS7 signaling packets between said originating VoIP gateway switch and said terminating VoIP gateway switch to provide for least cost, look ahead routing of VoIP telephone calls.

35. A method of reducing cost of setting up a voice over Internet protocol (VoIP) telephone call comprising exchanging enhanced SS7 signaling packets between an originating VoIP gateway switch and a terminating VoIP gateway switch to provide for least cost, look ahead routing at said terminating VoIP gateway switch.
